(19) United States
(12) Patent Application Publication
(10) Pub. No.: US 2024/0062398 A1
(43) Pub. Date: Feb. 22, 2024

(54) DEPTH SENSING APPARATUS AND DEPTH MAP GENERATING METHOD

(71) Applicant: HIMAX TECHNOLOGIES LIMITED, Tainan City (TW)

(72) Inventors: Hsueh-Tsung LU, Tainan City (TW); Ching-Wen WANG, Tainan City (TW); Cheng Che TSAI, Tainan City (TW); Wu-Feng CHEN, Tainan City (TW)

(21) Appl. No.: 17/821,185

(22) Filed: Aug. 21, 2022

(51) Int. Cl. G06T 7/55; H04N 5/235

(52) U.S. Cl. CPC G06T 7/55; H04N 5/2352; G06T 2207/10144; G06T 2207/10028

(57) ABSTRACT

A depth sensing apparatus includes an image sensor, a depth decoder and a depth fusion processor. The mage sensor captures raw images from a scene with different exposure configurations. The depth decoder decodes each raw image into depth values, each raw image having pixels respectively corresponding to the depth values. The depth fusion processor sets one of the raw images and the rest of at least one raw image as a base image and at least one reference image, respectively, and substitutes invalid depth values of the depth values corresponding to the base image with valid depth values corresponding to the at least one reference image to generate a depth map of the scene. The invalid depth values corresponding to the base image and the valid depth values corresponding to the at least one reference image map to the same pixels of the raw images.

### BACKGROUND

### Technical Field

The invention relates to a depth sensing apparatus and a depth map generating method for three-dimensional depth sensing.

### Description of Related Art

Three-dimensional (3D) depth sensing technologies have been applied in various fields, such as face recognition and obstacle detection. Among these applications, the structured light 3D sensor produces a special speckle optical pattern on an object by a projector module, and an image sensing element of the structured light 3D sensor receives the reflected lights forming an image from the object. Then, the structured light 3D sensor decodes the image to calculate the depth of the object. However, the light source of the optical pattern is infrared of which the wavelength is in 850 nm or 940 nm. The light source has bad reflected characteristics in a steaming environment or to the object made of some kind of materials such as acrylic, which would cause the intensity of reflected lights lower from the image sensing element and decrease signal-to-noise ratio (SNR), resulting in performance degradation for depth decoding. Therefore, it is hard to capture the image with only one exposure configuration to satisfy better performances for the depths decoding of all objects from a scene.

### SUMMARY

One aspect of the invention relates to a depth sensing apparatus which includes an image sensor, a depth decoder and a depth fusion processor. The image sensor is configured to capture raw images from a scene with different exposure configurations. The depth decoder is configured to decode each raw image into depth values. Each raw image has pixels respectively corresponding to the depth values. The depth fusion processor is configured to set one of the raw images and the rest of at least one raw image as a base image and at least one reference image, respectively, and to substitute invalid depth values of the depth values corresponding to the base image with valid depth values corresponding to the at least one reference image to generate a depth map of the scene. The invalid depth values corresponding to the base image and the valid depth values corresponding to the at least one reference image map to the same pixels of the raw images.

In one or more embodiments, the depth fusion processor is configured to generate a mask to replace the invalid depth values and then to fill the mask with the valid depth values to generate the depth map of the scene.

In one or more embodiments, the depth fusion processor is configured to weight the depth values corresponding to the raw images with different exposure configurations according to an operational condition and then to substitute the invalid depth values with the valid depth values selected based on the weighted depth values.

In one or more embodiments, the depth fusion processor is configured to weight the depth values corresponding to the raw images with different exposure configurations according to differences between the depth values corresponding to the base image and the depth values corresponding to the at least one reference image and then to substitute the invalid depth values with the valid depth values selected based on the weighted depth values.

In one or more embodiments, the depth sensing apparatus further includes an automatic exposure controller electrically connected to the image sensor, the automatic exposure controller configured to feedback control the exposure configuration of the image sensor according to clarities of the raw images.

In one or more embodiments, the depth fusion processor is configured to generate the depth map of the scene only with the depth values of the base image if there is no invalid depth value in the base image.

In one or more embodiments, a number of invalid depth values corresponding to the base image is less than a number of invalid depth values in each of the at least one reference image.

In one or more embodiments, the exposure configurations comprise at least one of a sensor exposure time and a sensor analog gain.

Another aspect of the invention relates to a depth map generating method, which includes: capturing a plurality of raw images from a scene with different exposure configurations; decoding each raw image into a plurality of depth values corresponding to a plurality of pixels respectively; setting one of the raw images and the rest of at least one raw image as a base image and at least one reference image respectively; and substituting invalid depth values of the depth values corresponding to the base image with valid depth values corresponding to the at least one reference image to generate a depth map of the scene, wherein the invalid depth values corresponding to the base image and the valid depth values corresponding to the at least one reference image map to the same pixels of the raw images.

In one or more embodiments, the method further includes: determining whether the invalid depth values of the depth values exist in the base image before the step of substituting the invalid depth values.

In one or more embodiments, a mask is generated to replace the invalid depth values in the base image and then is filled with the valid depth values to generate the depth map of the scene if the invalid depth values are determined to exist in the base image.

In one or more embodiments, the method further includes: weighting the depth values corresponding to the raw images with different exposure configurations according to an operational condition before the step of substituting invalid depth values; and substituting the invalid depth values with the valid depth values selected based on the weighted depth values.

In one or more embodiments, the method further includes: weighting the depth values corresponding to the raw images with different exposure configurations according to differences between the depth values corresponding to the base image and the depth values corresponding to the at least one reference image before the step of substituting invalid depth values; and substituting the invalid depth values with the valid depth values selected based on the weighted depth values.

In one or more embodiments, the method further includes feedback controlling the exposure configuration according to clarities of the raw images.

In one or more embodiments, the depth map of the scene is generated only with the depth values of the base image if no invalid depth value is determined to exist in the base image.

### BRIEF DESCRIPTION OF THE DRAWINGS

Embodiments and advantages thereof can be more fully understood by reading the following description with reference made to the accompanying drawings as follows:

FIG. 1 is a schematic block diagram of a depth sensing apparatus in accordance with some embodiments of the invention.

FIG. 2 is a flowchart of a depth map generating method in accordance with one embodiment of the invention.

FIG. 3 exemplarily illustrates generation of a depth map corresponding to a fused image from raw images by the depth sensing apparatus in FIG. 1.

FIG. 4 is a flowchart of a depth map generating method in accordance with another embodiment of the invention.

FIG. 5 is a flowchart of a depth map generating method in accordance with another embodiment of the invention.

### DETAILED DESCRIPTION

The spirit of the disclosure is clearly described hereinafter accompanying with the drawings and detailed descriptions. After realizing preferred embodiments of the disclosure, any persons having ordinary skill in the art may make various modifications and changes according to the techniques taught in the disclosure without departing from the spirit and scope of the disclosure.

Terms used herein are only used to describe the specific embodiments, which are not used to limit the claims appended herewith. Unless limited otherwise, the term “a,” “an,” “one” or “the” of the single form may also represent the plural form.

The document may repeat reference numerals and/or letters in the various examples. This repetition is for the purpose of simplicity and clarity and does not in itself dictate a relationship between the various embodiments and/or configurations discussed.

It will be understood that, although the terms “first,” “second,” “third” and so on may be used herein to describe various elements and/or components, these elements and/or components should not be limited by these terms. These terms are only used to distinguish elements and/or components.

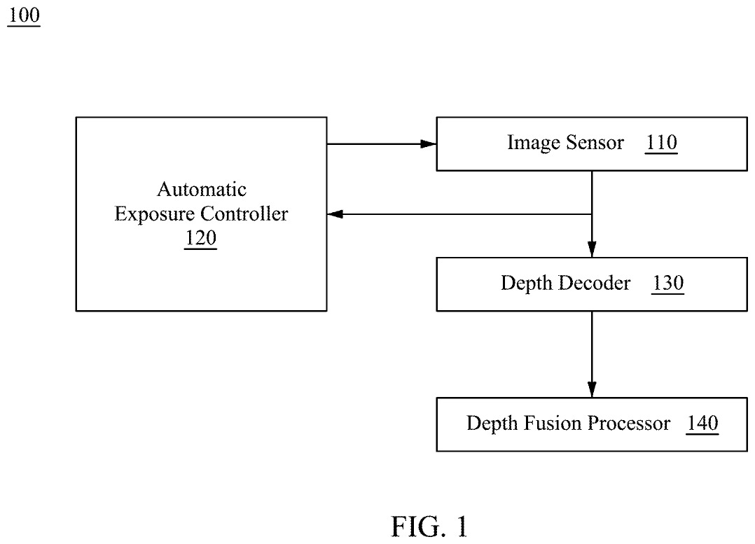

Referring to FIG. 1, FIG. 1 is a schematic block diagram of a depth sensing apparatus 100 in accordance with some embodiments of the invention. The depth sensing apparatus 100 may be a standalone apparatus or may be a part of an electronic device, such as a mobile phone, a tablet, a smartglass, and/or the like. The depth sensing apparatus 100 includes an image sensor 110, an automatic exposure controller 120, a depth decoder 130 and a depth fusion processor 140. The automatic exposure controller 120 is electrically connected to the image sensor 110, and the depth decoder 130 is electrically connected to the image sensor 110 and the depth fusion processor 140. The depth sensing apparatus 100 may be used as a structured light 3D sensor, but the invention is not limited thereto.

The image sensor 110 is configured to capture raw images from a scene with different exposure configurations. The exposure configurations may include a sensor exposure time, a sensor analog gain, and/or the like. The image sensor 110 may be a charge-coupled device (CCD) sensor, a complementary metal-oxide semiconductor (CMOS) sensor, or the like.

The automatic exposure controller 120 is configured to feedback control the exposure configuration of the image sensor 110 to adapt to the scene for image capturing according to clarities of the raw images. When the image sensor 110 captures and transmits each raw image to the automatic exposure controller 120, the automatic exposure controller 120 may dynamically control the exposure configuration of the image sensor 110 depending on the raw images captured by the image sensor 110.

The depth decoder 130 is configured to decode each raw image into a plurality of depth values. The pixels of each raw image respectively correspond to the depth values. For example, the gray scale of each pixel of each raw image is transformed into a depth value.

The depth fusion processor 140 is configured to set one of the raw images and the rest of at least one raw image as a base image and at least one reference image, respectively, and to compensate the base image with the reference image(s) to generate a depth map of the scene. The depth fusion processor 140 may be a central processing unit (CPU), a microprocessor, a microcontroller, a digital signal processor (DSP), an image processing chip, an application-specific integrated circuit (ASIC), or the like.

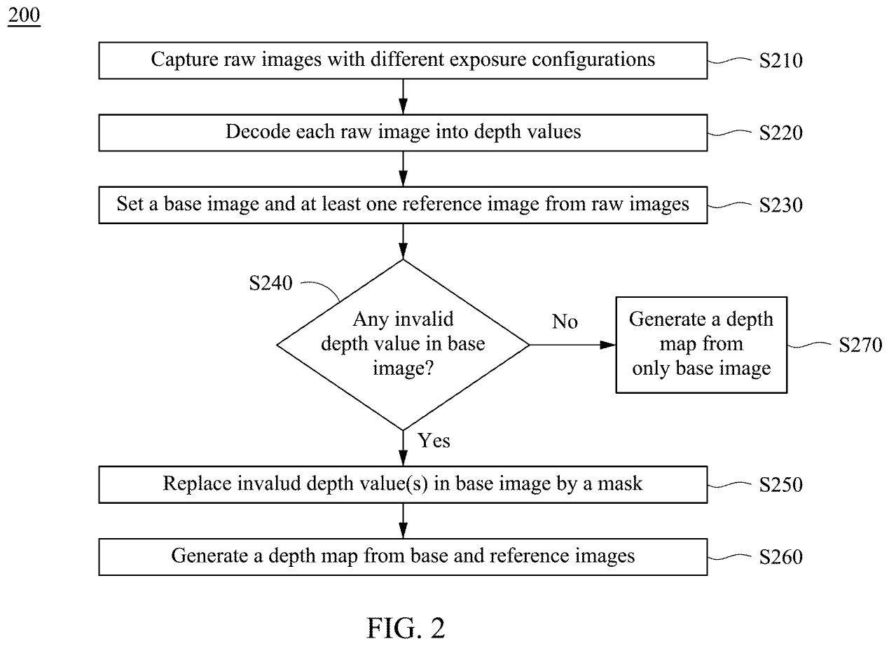

FIG. 2 is a flowchart of a depth map generating method 200 in accordance with one embodiment of the invention. The depth map generating method 200 may be applied to the depth sensing apparatus 100 in FIG. 1 or another similar depth sensing apparatus. The depth map generating method 200 applied to the depth sensing apparatus 100 is exemplified for the description as follows.

In Step S210, the image sensor 110 captures raw images from a scene with different exposure configurations. In Step S220, the depth decoder 130 decodes each raw image into a plurality of depth values respectively corresponding to a plurality of pixels. In Step S230, the depth fusion processor 140 sets one of the raw images and the rest of at least one raw image as a base image and at least one reference image, respectively. The depth fusion processor 140 may set the base image and the at least one reference image based on amount of invalid depth values of the depth values in each raw image in one example, but is not limited in this regard. Therefore, a number of invalid depth values of the depth values corresponding to the base image may be less than a number of invalid depth values of the depth values in each of the at least one reference image. In another example, the depth fusion processor may set the base image and the at least one reference image based on an operational condition, but is not limited in this regard. For example, if the depth map of the scene is applied to a face recognition technology, the depth fusion processor 140 may serve the raw image with the exposure configuration at a near range as the base image.

In Step S240, the depth fusion processor 140 determines whether the invalid depth values of the depth values exist in the base image. In Step S250, the depth fusion processor 140 generates a mask to replace the invalid depth values in the base image if the invalid depth values are determined to exist in the base image. In Step S260, the depth fusion processor 140 substitutes invalid depth values of the depth values corresponding to the base image with valid depth values of the depth values corresponding to the at least one reference image to generate a depth map of the scene. The invalid depth values corresponding to the base image and the valid depth values corresponding to the at least one reference image map to the same pixels of the raw images. That is, the mask in the base image is filled with the valid depth values of the depth values in the at least one reference image to generate the depth map of the scene. Through substituting invalid depth values corresponding to the base image with valid depth values corresponding to the at least one reference image compensates the base image to generate the depth map of the scene with optimizing the depth values. In Step S270, the depth fusion processor 140 generates the depth map of the scene only with the depth values of the base image if there is no invalid depth value in the base image.

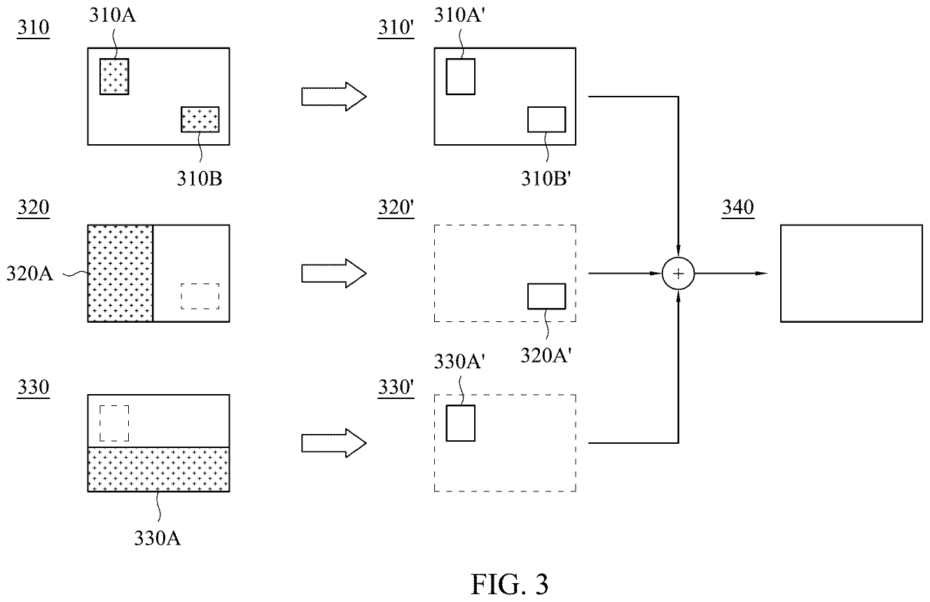

For example, as shown in FIG. 3, the image sensor 110 captures three raw images 310, 320 and 330 with different exposure configurations. In this example, the number of invalid depth values corresponding to the regions 310A and 310B of the raw image 310 is less than that corresponding to the region 320A of the raw image 320 and that corresponding to the region 330A of the raw image 330 (the area of the regions 310A and 3106 is less than the area of the region 320A and the area of the region 330A), and thus the raw image 310 is set as a base image 310′ with masks 310A′ and 310B′ respectively in place of the regions 310A and 310B, while the raw images 320 and 330 are set as reference images 320′ and 330′ respectively with regions 320A′ and 330A′. The region 320A′ and the mask 310B′ map to the same pixels, and the region 330A′ and the mask 310A′ map to the same pixels. The depth fusion processor 140 then fills the masks 310A′ and 310B′ of the base image 310′ respectively with the valid depth values corresponding to the region 320A′ of the reference image 320′ and the region 330A′ of the reference image 330′ to generate a depth map with all valid depth values corresponding to a fused image 340.

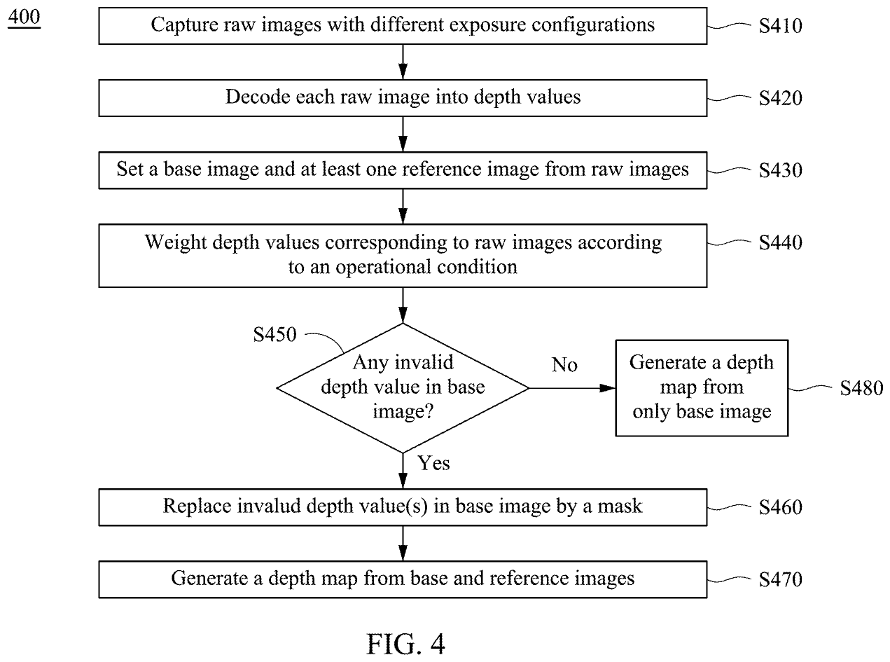

FIG. 4 is a flowchart of a depth map generating method 400 in accordance with another embodiment of the invention. The depth map generating method 400 may be applied to the depth sensing apparatus 100 or another similar depth sensing apparatus. Similarly, the depth map generating method 400 applied to the depth sensing apparatus 100 is exemplified for the description as follows.

The difference between the depth map generating methods 200 and 400 is that the depth map generating method 400 further includes a weighting operation according to an operational condition. Particularly, in Step S440, the depth fusion processor 140 weights the depth values corresponding to the raw images with different exposure configurations according to an operational condition. The condition may be a user instruction or a preset of software. The weighted depth value represents the importance for reference about the depth value corresponding to the raw image with the corresponding exposure configuration or whether the depth value corresponding to the raw image with the corresponding exposure configuration is referenced for substituting invalid depth values corresponding to the base image.

For face recognition, the depth fusion processor 140 may weight the depth values corresponding to the raw images with different exposure configurations. In one exemplary example, the depth fusion processor 140 weights the depth values with the exposure configuration at a relatively near range higher than the depth values with the exposure configuration at a relatively far range.

Moreover, in Step S470, the depth fusion processor 140 fills the mask in the base image with the valid depth values selected based on the weighted depth values in the at least one reference image to generate the depth map of the scene, such that the depth map of the scene is more elastic for application in various fields. Steps S410, S420, S430, S450, S460 and S480 are respectively similar to Steps S210, S220, S230, S240, S250 and S270 of the depth map generating method 200, and thus the detailed descriptions thereof are not repeated herein.

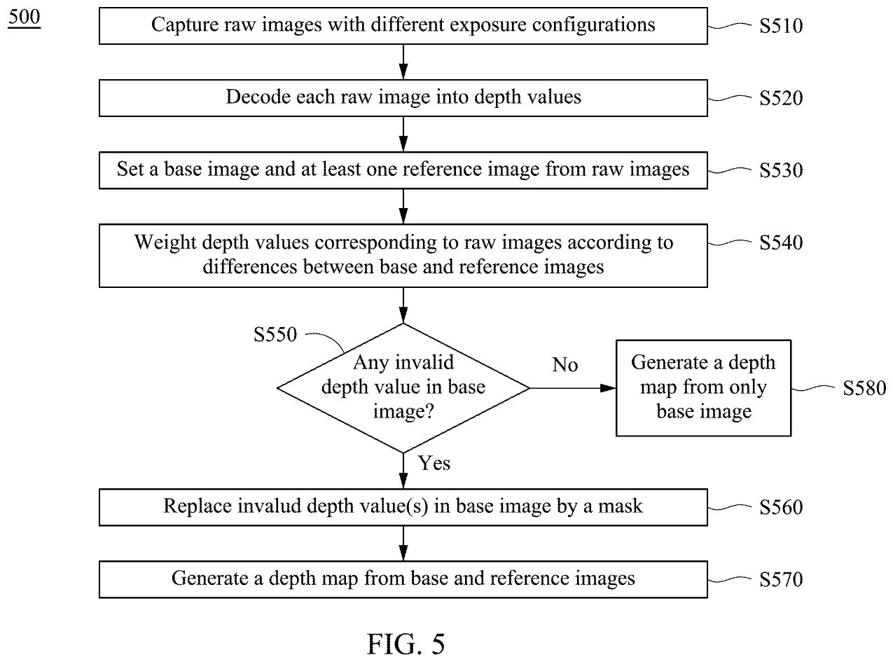

FIG. 5 is a flowchart of a depth map generating method 500 in accordance with another embodiment of the invention. The depth map generating method 500 may be applied to the depth sensing apparatus 100 or another similar depth sensing apparatus. Similarly, the depth map generating method 500 applied to the depth sensing apparatus 100 is exemplified for the description as follows.

The difference between the depth map generating methods 200 and 500 is that the depth map generating method 500 further includes a weighting operation according to differences between the depth values respectively corresponding to the base image and the reference image(s). Particularly, in Step S540, the depth fusion processor 140 weights the depth values corresponding to the raw images with different exposure configurations according to differences between the depth values corresponding to the base image and the depth values corresponding to the at least one reference image. In Step S570, the depth fusion processor 140 fill the mask in the base image with the valid depth values selected based on the weighted depth values in the at least one reference image to generate the depth map of the scene. The structured light may be different in a low signal-to-noise ratio (SNR) area in various exposure configurations, and thus all depth values corresponding to the same pixel in the raw images with different exposure configurations may be referenced. The depth fusion processor 140 may determine a suitable depth value according to the differences between the depth value corresponding to the base image and the depth value corresponding to the reference images, and control to output a correct depth value by weighting the depth values.

In a case where only one reference image is used for compensation, the difference between the depth value corresponding to the base image and the depth value corresponding to the reference image is greater than a threshold such that the depth fusion processor 140 may not determine the correct depth value, the depth fusion processor 140 may weight the depth values to zeros for not being referenced in order to avoid outputting an incorrect depth value. If the difference between the depth value corresponding to the base image and the depth value corresponding to the reference image is in a range of the threshold such that the depth fusion processor may determine the correct depth value, the depth fusion processor may weight the depth values to ones for being referenced.

In a case where plural reference images are used for compensation, the depth fusion processor 140 may make statistics according to the differences between the depth value corresponding to the base image and the depth values corresponding to the reference images. The depth fusion processor 140 may delete statistical outliers by weighting the depth value of the outlier to zero for not being referenced. By implementing the operations described above, the noise of the depth map of the scene may be decreased. Steps S510, S520, S530, S550, S560 and S580 are similar to Steps S210, S220, S230, S240, S250 and S270 of the depth map generating method 200, respectively, and thus the detailed descriptions thereof are not repeated herein.

Summing the above, the depth sensing apparatus and the depth map generating method in accordance with the embodiments of the invention can compensate the base image due to different reflected characteristics of the light source resulting in incomplete decoding depth values by substituting invalid depth values with valid depth values, so as to generate the depth map of the scene with optimizing the depth values. It is acceptable to generate the depth map of the objects of composite materials for application. In addition, by weighting the depth values according to the operational condition, the depth map from the scene is more elastic for application in various fields. Further, by weighting the depth values according to differences between the depth values, the accuracy for the depth values of the depth map from the scene is increased.

Although the invention is described above by means of the implementation manners, the above description is not intended to limit the invention. A person of ordinary skill in the art can make various variations and modifications without departing from the spirit and scope of the invention, and therefore, the protection scope of the invention is as defined in the appended claims.

1. A depth sensing apparatus, comprising:
an image sensor configured to capture a plurality of raw images from a scene with different exposure configurations;
a depth decoder electrically connected to the image sensor, the depth decoder configured to decode each raw image into a plurality of depth values, each raw image having a plurality of pixels respectively corresponding to the depth values; and
a depth fusion processor electrically connected to the depth decoder, the depth fusion processor configured to set one of the raw images and the rest of at least one raw image as a base image and at least one reference image, respectively, and to substitute invalid depth values of the depth values corresponding to the base image with valid depth values corresponding to the at least one reference image to generate a depth map of the scene, wherein the invalid depth values corresponding to the base image and the valid depth values corresponding to the at least one reference image map to the same pixels of the raw images.

2. The depth sensing apparatus of claim 1, wherein the depth fusion processor is configured to generate a mask to replace the invalid depth values and then to fill the mask with the valid depth values to generate the depth map of the scene.

3. The depth sensing apparatus of claim 1, wherein the depth fusion processor is configured to weight the depth values corresponding to the raw images with different exposure configurations according to an operational condition and then to substitute the invalid depth values with the valid depth values selected based on the weighted depth values.

4. The depth sensing apparatus of claim 1, wherein the depth fusion processor is configured to weight the depth values corresponding to the raw images with different exposure configurations according to differences between the depth values corresponding to the base image and the depth values corresponding to the at least one reference image and then to substitute the invalid depth values with the valid depth values selected based on the weighted depth values.

5. The depth sensing apparatus of claim 1, further comprising:
an automatic exposure controller electrically connected to the image sensor, the automatic exposure controller configured to feedback control the exposure configuration of the image sensor according to clarities of the raw images.

6. The depth sensing apparatus of claim 1, wherein the depth fusion processor is configured to generate the depth map of the scene only with the depth values of the base image if there is no invalid depth value in the base image.

7. The depth sensing apparatus of claim 1, wherein a number of invalid depth values corresponding to the base image is less than a number of invalid depth values in each of the at least one reference image.

8. The depth sensing apparatus of claim 1, wherein the exposure configurations comprise at least one of a sensor exposure time and a sensor analog gain.

9. A depth map generating method, comprising:
capturing a plurality of raw images from a scene with different exposure configurations by the same image sensor;
decoding each raw image into a plurality of depth values corresponding to a plurality of pixels respectively;
setting one of the raw images and the rest of at least one raw image as a base image and at least one reference image respectively; and
substituting invalid depth values of the depth values corresponding to the base image with valid depth values corresponding to the at least one reference image to generate a depth map of the scene, wherein the invalid depth values corresponding to the base image and the valid depth values corresponding to the at least one reference image map to the same pixels of the raw images.

10. The depth map generating method of claim 9, further comprising:
determining whether the invalid depth values of the depth values exist in the base image before the step of substituting the invalid depth values.

11. The depth map generating method of claim 9, wherein a mask is generated to replace the invalid depth values in the base image and then is filled with the valid depth values to generate the depth map of the scene if the invalid depth values are determined to exist in the base image.

12. The depth map generating method of claim 9, further comprising:
weighting the depth values corresponding to the raw images with different exposure configurations according to an operational condition before the step of substituting invalid depth values; and
substituting the invalid depth values with the valid depth values selected based on the weighted depth values.

13. The depth map generating method of claim 9, further comprising:
weighting the depth values corresponding to the raw images with different exposure configurations according to differences between the depth values corresponding to the base image and the depth values corresponding to the at least one reference image before the step of substituting invalid depth values; and
substituting the invalid depth values with the valid depth values selected based on the weighted depth values.

14. The depth map generating method of claim 9, further comprising:
feedback controlling the exposure configuration according to clarities of the raw images.

15. The depth map generating method of claim 9, wherein the depth map of the scene is generated only with the depth values of the base image if no invalid depth value is determined to exist in the base image.
